(19) United States
(12) Patent Application Publication
(10) Pub. No.: US 2020/0302495 A1
(43) Pub. Date: Sep. 24, 2020

(54) AUTOMATING PRODUCT REVIEW AND USAGE INFORMATION

(71) Applicant: International Business Machines Corporation, Armonk, NY (US)

(72) Inventors: Robert WILHELM, Cheyenne, WY (US); Derek BREWER, Bowling Green, OH (US)

(21) Appl. No.: 16/362,024

(22) Filed: Mar. 22, 2019

(51) Int. Cl. G06Q 30/02; G06F 17/27

(52) U.S. Cl. CPC G06Q 30/0282; G06F 17/2785; G06Q 30/0201

(57) ABSTRACT

Techniques for usage data processing are provided. A plurality of usage statistics are received, where each of the plurality of usage statistics corresponds to a respective device operated by a user. A respective device type of the corresponding respective device is determined, for each of the plurality of usage statistics. A first aggregate statistic is generated for a first device type, based on the plurality of usage statistics. A first request for details regarding the first device type is received, and, responsive to the first request, the first aggregate statistic is provided.

### BACKGROUND

The present disclosure relates to collecting usage information, and more specifically, to automatically aggregating usage information for products.

Many services and retailers allow users to submit ratings and reviews describing products they own or have purchased. Research has shown that consumers rely heavily on these reviews when deciding between otherwise similar items. However, reviewing the individual ratings and comments is a time-consuming process, and it is difficult or impossible to come to a cohesive and objective determination, as the subjectivity and biases of the prospective purchaser are likely to interfere. Further, these reviews are often of questionable value, as it is frequently not clear whether the reviewer was paid for their review (or if they even own the item at all). Additionally, reviews are often inaccurate in that the reviewer is rating the item based at least in part on irrelevant factors such as their experience with purchasing, delivery, and the like. Further, the reviews are typically static, and potential customers cannot readily determine, for example, whether the item stopped working a few months after the review, or if the object is still in use by the purchaser.

### SUMMARY

According to one embodiment of the present disclosure, a method is provided. The method includes receiving a plurality of usage statistics, wherein each of the plurality of usage statistics corresponds to a respective device operated by a user. The method also includes determining, for each of the plurality of usage statistics, a respective device type of the corresponding respective device. Additionally, the method includes generating, by operation of one or more computer processors, a first aggregate statistic for a first device type, based on the plurality of usage statistics. The method further includes receiving a first request for details regarding the first device type, and, responsive to the first request, providing the first aggregate statistic.

According to a second embodiment of the present disclosure, a computer-readable storage medium is provided. The computer-readable storage medium has computer-readable program code embodied therewith, the computer-readable program code executable by one or more computer processors to perform an operation. The operation includes receiving a plurality of usage statistics, wherein each of the plurality of usage statistics corresponds to a respective device operated by a user. The operation also includes determining, for each of the plurality of usage statistics, a respective device type of the corresponding respective device. Additionally, the operation includes generating a first aggregate statistic for a first device type, based on the plurality of usage statistics. The operation further includes receiving a first request for details regarding the first device type, and, responsive to the first request, providing the first aggregate statistic.

According to a third embodiment of the present disclosure, a system is provided. The system includes one or more computer processors, and a memory containing a program which when executed by the one or more computer processors performs an operation. The operation includes receiving a plurality of usage statistics, wherein each of the plurality of usage statistics corresponds to a respective device operated by a user. The operation also includes determining, for each of the plurality of usage statistics, a respective device type of the corresponding respective device. Additionally, the operation includes generating a first aggregate statistic for a first device type, based on the plurality of usage statistics. The operation further includes receiving a first request for details regarding the first device type, and, responsive to the first request, providing the first aggregate statistic.

### BRIEF DESCRIPTION OF THE SEVERAL VIEWS OF THE DRAWINGS

FIG. 1 illustrates an environment for automatic collection and aggregation of usage statistics, according to one embodiment disclosed herein.

FIG. 2 is a block diagram illustrating an analysis device configured to collect and aggregate usage data, according to one embodiment disclosed herein.

FIGS. 3A and 3B illustrate graphical user interfaces displaying aggregated usage statistics that were automatically collected and processed, according to one embodiment disclosed herein.

FIG. 4 is a flow diagram illustrating a method for automatically collecting and aggregating usage information, according to one embodiment disclosed herein.

FIG. 5 is a flow diagram illustrating a method for automatically updating aggregated statistics, according to one embodiment disclosed herein.

FIG. 6 is a flow diagram illustrating a method for collecting usage data, according to one embodiment disclosed herein.

### DETAILED DESCRIPTION

Embodiments of the present disclosure provide techniques and systems to automatically collect usage data across time, and to aggregate the data based on a variety of factors. This aggregated data can be provided to retailers, manufacturers, and designers to aid in the design and manufacture of improved devices. Further, this information can be supplied to users to enable better-informed decision making. In an embodiment, purchased devices collect usage information and transmit it periodically or continuously to one or more defined collection points, where it is aggregated in a number of ways. In one embodiment, the data can be aggregate based on the type of the device it is collected from. For example, all usage data that relates to a particular brand and model of smartphone can be collected to generate aggregate data that can be used to objectively compare the phone against other phones.

In some embodiments, the statistics can further be aggregated on a per-user basis, to allow potential purchases to determine how much trust to place in a given review. For example, in one embodiment, a review can be associated with usage statistics for the user leaving the review (e.g., how many hours they have used the product, how long they have owned the product, and the like). In this way, users can readily determine whether the reviewing user should be trusted. In some embodiments, usage data is collected automatically from devices. For example, a television may monitor the total amount of time it has been active, and report this value to a collecting point. In some embodiments, data can also be collected through other avenues. For example, in one embodiment, users may manually report bugs or defects (e.g., to a support or help line for the product). In one embodiment, these reports can also be collected and aggregated. Further, in one embodiment, the system can transmit requests to users to submit updated data, as discussed in more detail below.

In embodiments, the monitored devices can include any item, including laptops, telephones, televisions, cars, watches, and other electronic devices. In some embodiments, non-electronic devices can similarly be monitored. For example, in an embodiment, while electronic devices may be configured to record and self-report statistics, in embodiments, users can report usage information regarding any item including non-electronic devices, such as furniture. Embodiments of the present disclosure enable the trustworthiness and accuracy of otherwise anonymous reviews and data to be improved, which facilitates more efficient and accurate decision-making that reduces subjectivity.

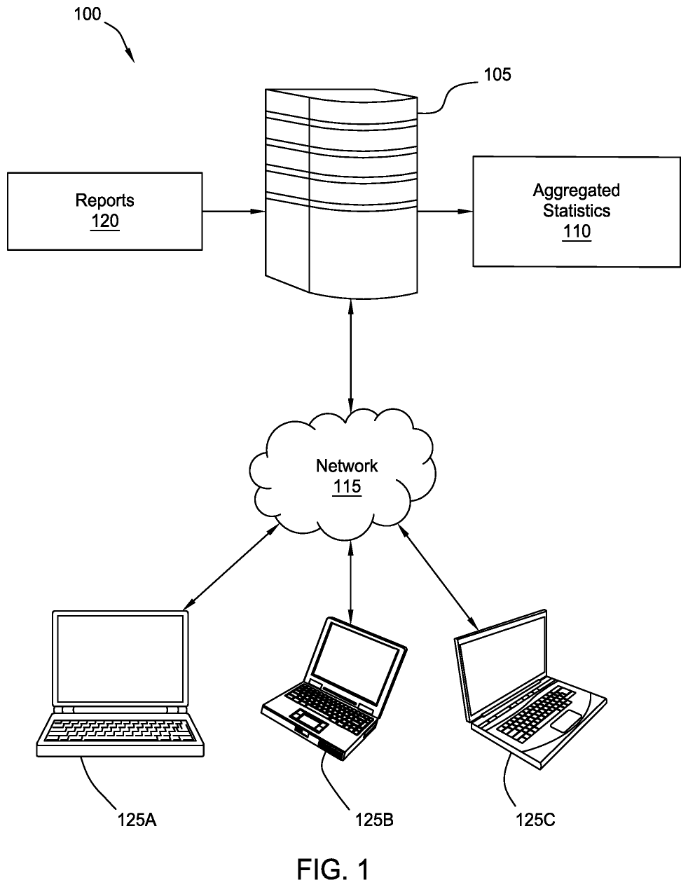

FIG. 1 illustrates an environment 100 for automatic collection and aggregation of usage statistics, according to one embodiment disclosed herein. As illustrated, a set of Devices 125A-C collect and report usage statistics to an Analysis Device 105, via a Network 115. In the illustrated embodiment, the Devices 125A-C are laptops. However, in embodiments, the Devices 125 can include any device, product, or item. In one embodiment, the Network 115 is the Internet. In some embodiments, the Analysis Device 105 operates as part of a Cloud infrastructure. In one embodiment, the Analysis Device 105 is implemented by a third party which provides the aggregated data to manufacturers, retailers, and the like. In some embodiments, the Analysis Device 105 is operated directly by the manufacturer or retailer, to collect data about the products they produce or sell.

In some embodiments, the Devices 125 collect and periodically transmit their usage statistics to the Analysis Device 105. In some embodiments, this data is continuously transmitted as it becomes available. In one embodiment, the Analysis Device 105 periodically requests that each Device 105 transmit its usage data. In embodiments, the usage statistics can include any type of data. In one embodiment, the type of data collected may depend at least in part on the device. For example, in various embodiments, the Analysis Device 105 may collect data related to the total active duration for the device (e.g., the number of hours it has been active or in use), the average active duration (e.g., how long it is used for in a typical session or day), battery life of the device, any problems related to the device (either self-identified, or reported by the user), and the like. As additional examples, if the device is a vehicle, the Analysis Device 105 may further collect data related to total mileage, average miles per gallon (or miles per charge, if it is an electric vehicle), maximum and/or average speed, and the like.

Further, in some embodiments, the usage statistics can include any relevant parameter or setting, such as the brightness setting used for a display, the color or clarity settings in use on a television, and the like. In some embodiments, the usage statistics to be collected are defined by an administrator, or by the designer and/or manufacturer of the Device 125. In the illustrated embodiment, in addition to this data, the Analysis Device 105 further collects or receives Reports 120 from one or more sources. In an embodiment, each Report 120 is a user-submitted report or complaint related to the product. For example, in one embodiment, a Report 120 can include a complaint or bug report submitted to a help line, service department, online forum, and the like. In various embodiments, the Reports 120 can include any user-submitted requests or details.

In one embodiment, one or more of the Reports 120 include natural language text (e.g., a paragraph describing the problem). In an embodiment, the Analysis Device 105 can process each of these Reports 120 to determine the user and/or Device 125 it corresponds to (e.g., the Device 125 that the user is complaining about). Additionally, in some embodiments, the Analysis Device 105 utilizes one or more natural language processing (NLP) techniques to identify the issues being discussed. For example, if the report states that the user is having trouble with battery life, the Analysis Device 105 can determine that a “battery life” statistic is relevant, and further determine that the user of the identified Device 125 is dissatisfied with the battery life.

In the illustrated embodiment, based on the collected statistics (including Reports 120), the Analysis Device 105 outputs one or more Aggregated Statistics 110. For example, in the illustrated embodiment, Aggregated Statistics 110 may be the average battery life experienced for each of the Devices 125, the average time they have been used (e.g., the average number of hours each user has used the device, since purchasing it), and the like. In some embodiments, each Aggregated Statistic 110 corresponds to a particular device type. As used herein, a device type refers to the device's particular manufacturer, model, and/or brand, such that otherwise similar devices can be compared. For example, a first Aggregated Statistic 110 may correspond to battery life for a laptop made by a first manufacturer, while a second Aggregated Statistic 110 indicates the battery life for a laptop made by a competing manufacturer (or a different laptop made by the same manufacturer).

In some embodiments, in addition to device-specific Aggregated Statistics 110 (or in the alternative), the Analysis Device 105 produces Aggregated Statistics 110 that are user-specific. For example, in an embodiment, each Device 125 is registered to a user upon purchase, and the usage data for that particular unique Device 125 are associated with the user. That is, data such as total active use, average battery life, and the like can be associated with a particular user. In such an embodiment, if a user submits a review or rating, the review can be associated with the relevant data for the individual user. For example, in an embodiment, the Analysis Device 105 can determine what device type the user is reviewing (e.g., the brand, model, and/or manufacturer of the particular Device 125), and can provide the user's individual statistics along with the review. In this way, in addition to reading the review and viewing any provided ratings, potential consumers can further review the objective that has been collected (e.g., how long the user has used the Device 125), to determine how much the review should be trusted.

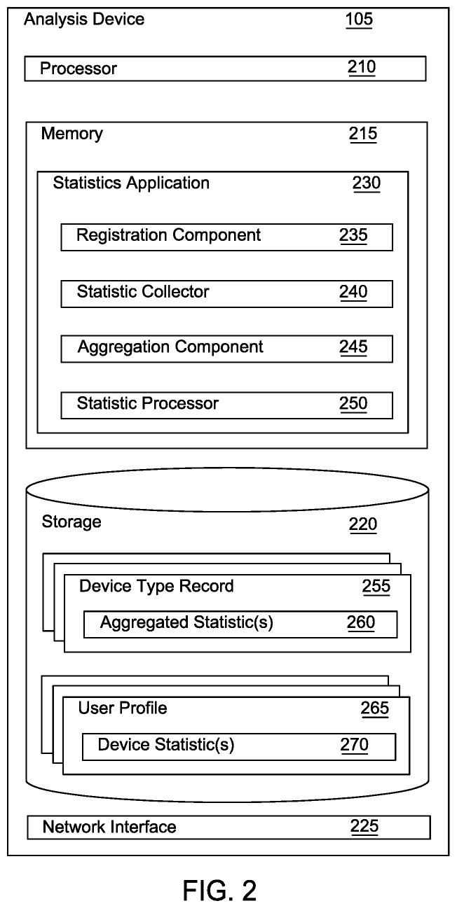

FIG. 2 is a block diagram illustrating an Analysis Device 105 configured to collect and aggregate usage data, according to one embodiment disclosed herein. In the illustrated embodiment, the Analysis Device 105 includes a Processor 210, a Memory 215, Storage 220, and a Network Interface 225. In the illustrated embodiment, Processor 210 retrieves and executes programming instructions stored in Memory 215 as well as stores and retrieves application data residing in Storage 220. Processor 210 is representative of a single CPU, multiple CPUs, a single CPU having multiple processing cores, and the like. Memory 215 is generally included to be representative of a random access memory. Storage 220 may be a disk drive or flash-based storage device, and may include fixed and/or removable storage devices, such as fixed disk drives, removable memory cards, or optical storage, network attached storage (NAS), or storage area-network (SAN). Via the Network Interface 225, the Analysis Device 105 can be communicatively coupled with one or more other devices including Devices 125 that are being monitored, servers that provide Reports 120 or complains, manufacturer or retailer servers, devices used by users to report statistics or problems, and the like.

Although illustrated as a discrete device, in some embodiments, the Analysis Device 105 is implemented on one or more virtual machines. In the illustrated embodiment, the Storage 220 includes a set of Device Type Records 255. In an embodiment, each Device Type Record 255 corresponds to a particular device type (e.g., a particular make and model of laptop). As illustrated, each Device Type Record 255 includes a set of one or more Aggregated Statistics 260 for the corresponding device type. For example, for a Device Type Record 255 that corresponds to a laptop model, the Aggregated Statistics 260 can include data such as the average battery life (as collected from devices used by any number of users). Similarly, for a Device Type Record 255 corresponding to a make and model of vehicle, the Aggregated Statistics 260 may include average mileage reported by any number of such vehicles, average miles per gallon, and the like.

In the illustrated embodiment, the Storage 220 further includes a set of User Profiles 265. In an embodiment, each User Profile 265 corresponds to a particular user or individual who uses or operates at least one device that is being monitored. In one embodiment, in addition to identifying the corresponding user, each User Profile 265 also indicates some way of contacting the user, such as an email address, a phone number, and the like. As illustrated, each User Profile 265 includes a set of one or more Device Statistics 270. In an embodiment, each Device Statistic 270 corresponds to a device owned and/or operated by the user. For example, a first Device Statistic 270 may correspond to a laptop, while a second is associated with the user's smartphone. In an embodiment, each Device Statistic 270 includes statistics about the corresponding device, with respect to the corresponding user. For example, a Device Statistic 270 that corresponds to the user's laptop may indicate the average battery life of the laptop, as experienced by the user.

As illustrated, the Memory 215 includes a Statistics Application 230. Although illustrated as a program residing in Memory 215, in embodiments, the Statistics Application 230 can be implemented using hardware, software, or as a combination of hardware and software. In the illustrated embodiment, the Statistics Application 230 includes a Registration Component 235, a Statistic Collector 240, an Aggregation Component 245, and a Statistic Processor 250. Although depicted as discrete components for illustration, in embodiments, the operations and functionality of the Registration Component 235, Statistic Collector 240, Aggregation Component 245, and Statistic Processor 250 may be combined or divided across any number of components.

In an embodiment, the Registration Component 235 is used to register newly purchased or acquired devices, such that statistics and usage data can be collected for them. For example, in one embodiment, a user can access the Registration Component 235 to create and/or update their User Profile 265, such that it indicates that they are operating or using the new item. In an embodiment, during this registration process, the Registration Component 235 records the identity of the user, the unique identifier of the device being registered, and the device type of the device being registered. In some embodiments, the Registration Component 235 can further ask the user to confirm their selected method of communication, such that the Statistics Application 230 can successfully communicate with the user.

In an embodiment, the Statistic Collector 240 receives usage statistics from the registered devices. In one embodiment, the Statistic Collector 240 can also collect statistics from unregistered devices. For example, in one embodiment, devices may transmit anonymous data to the Statistic Collector 240 if the user has not registered it (e.g., if the user has chosen not to associate the device with a User Profile 265). In some embodiments, the Statistic Collector 240 further receives data such as Reports 120, for processing. In one embodiment, the Statistic Collector 240 can similarly request data from one or more sources and/or users. For example, in an embodiment, if the Statistic Collector 240 determines that predefined period of time has passed without receiving data from a particular device, the Statistic Collector 240 can identify the user who registered the device, and transmit a reminder or request to the user.

In some embodiments, the Statistic Collector 240 also performs any initial pre-processing that is required. For example, in one embodiment, when data is received, the Statistic Collector 240 identifies the corresponding device to which it relates, and labels the data with the appropriate device type for the underlying device. Further, in some embodiments, the Statistic Collector 240 determines whether the identified device is registered to a particular user. If so, the Statistic Collector 240 labels the data to indicate this user as well. Additionally, in one embodiment, if the data includes natural language text (e.g., if it is a Report 120), the Statistic Collector 240 performs NLP analysis to identify and extract the relevant statistics (e.g., to identify which problem(s) are being discussed).

In the illustrated embodiment, the Aggregation Component 245 receives the collected and/or labeled usage data from the Statistic Collector 240, and aggregates it. In one embodiment, aggregating the data includes aggregating the labeled statistics on a per-device type basis. In such an embodiment, the Aggregation Component 245 generates (or updates) the Aggregated Statistics 260 for each device type for which data was received. In some embodiments, the Aggregation Component 245 further aggregates the data on a per-user basis. In such an embodiment, the Aggregation Component 245 generates (or updates) the Device Statistics 270 for each user for which data was received.

In an embodiment, the Statistic Processor 250 provides the generated aggregate statistics, as appropriate. For example, in one embodiment, the Statistic Processor 250 is configured to receive requests from users or other entities (e.g., retailers), where the request indicates or specifies one or more device types and/or one or more types of statistic (e.g., average battery life). In such an embodiment, the Statistic Processor 250 can identify the corresponding Device Type Records 255, retrieve the relevant Aggregated Statistics 260, and transmit them to the requester. In some embodiments, the Statistic Processor 250 can further filter or sort the results, depending on the request (e.g., to exclude device types with a value below or above a specified threshold).

In some embodiments, the Statistic Processor 250 interfaces with one or more other applications (such as a browser plugin) to augment web pages. That is, in an embodiment, a user may use an application that modifies web pages based on the devices identified on the page. For example, when a user searches for “laptops” on an online shopping website, the application can detect the device types that are returned, and access the Statistic Processor 250 to retrieve the relevant statistics. These Aggregated Statistics 260 can then be displayed along with the items.

In one embodiment, the Statistic Processor 250 further retrieves and provides Device Statistics 270. For example, in an embodiment, the Statistic Processor 250 can analyze reviews to identify the user who posted it. If the user has an accompanying User Profile 265, the Statistic Processor 250 searches this profile to determine whether there are any Device Statistics 270 that are relevant to the review. For example, in one embodiment, the Statistic Processor 250 analyzes the review to identify the relevant device type (e.g., to identify labels specifying the device type being discussed, or using NLP to identify the device type). The Statistic Processor 250 can then retrieve any Device Statistics 270 from the User Profile 265 that correspond to this device type. In an embodiment, these statistics can then be provided or displayed to the user along with the review, to allow the user to determine how trustworthy the review is (e.g., how much time or experience the reviewing user has with the product being reviewed).

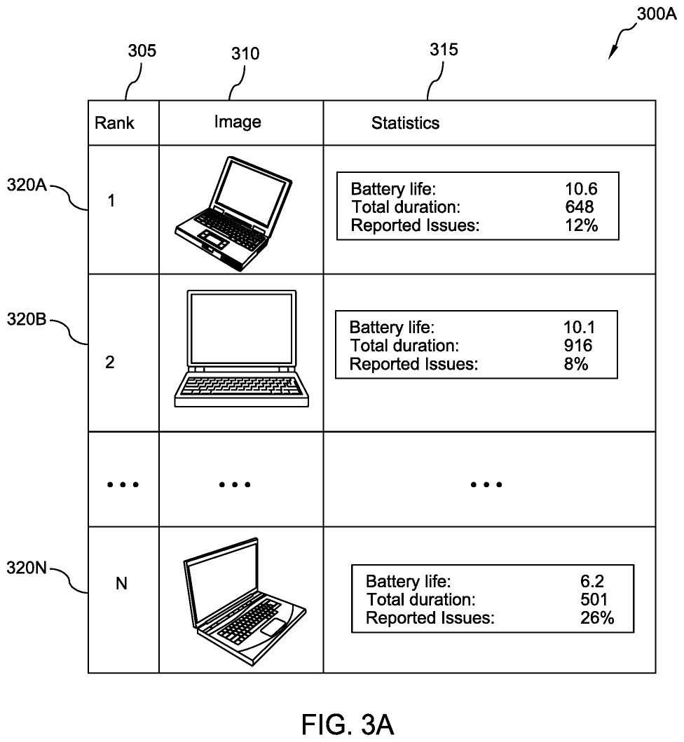

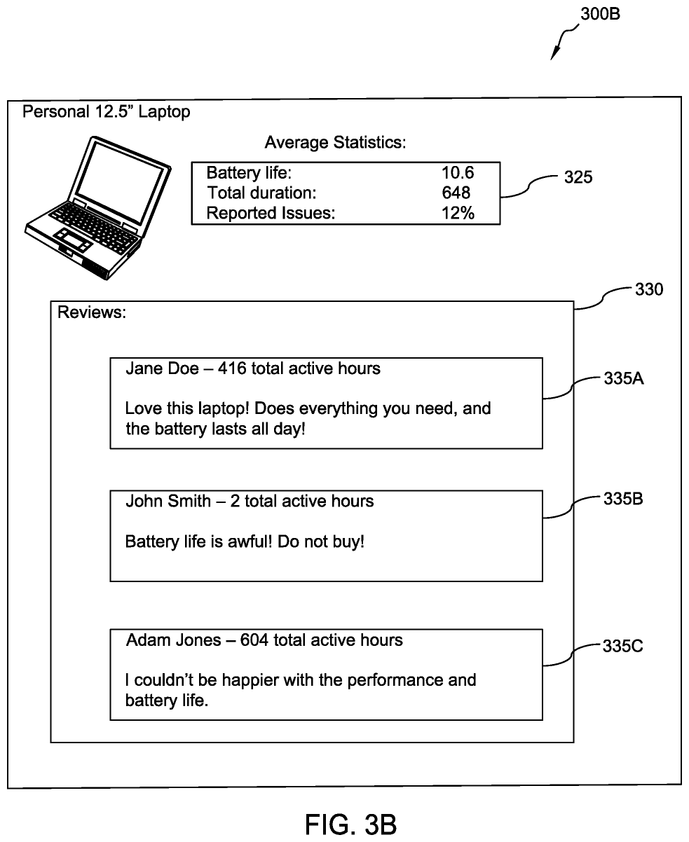

FIG. 3A illustrates a graphical user interface (GUI) 300A displaying aggregated usage statistics that were automatically collected and processed, according to one embodiment disclosed herein. In the illustrated embodiment, the GUI 300A includes a number of Entries 320A-N, where each entry corresponds to a product. In one embodiment, the GUI 300A is an online shopping portal where the user can compare and purchase items. As illustrated, the GUI 300A further includes a set of columns to organize the information for each Entry 320. In the illustrated embodiment, a first column indicates the Rank 305 of the respective Entry 320, a second column includes an Image 310 for the device type represented by the Entry 320, and a third column includes the retrieved Statistics 315 for the device type. In various embodiments, the GUI 300A may similarly include other information, such as a name or title for each Entry 320, a description for each Entry 320, one or more reviews or ratings for each Entry 320, a price for each Entry 320, and the like.

In one embodiment when the GUI 300A was being generated, all or a portion of each of the Entries 320 were transmitted to the Statistic Processor 250. In an embodiment, the Statistic Processor 250 then identified the relevant device types, retrieved the appropriate data, and returned it to be included in the GUI 300A. In the illustrated embodiment, the Statistics 315 for each Entry 320 include an average battery life for the relevant device type, an average total active duration for the device type, and a percentage of devices belonging to the device type that have reported at least one defined issue or problem. As discussed above, in embodiments, the statistics are collected and aggregated for a number of individual devices belonging to each device type. For example, for the device type represented by the first Entry 320A, the user can expect an average battery life of 10.6 hours.

Additionally, in the illustrated embodiment, the user can see that the devices included in the device type have logged an average of 648 hours since they were activated and/or registered. Based on this, the user can determine that the corresponding device type should be expected to last at least 648 hours, on average. Further, as indicated in the Entry 320A, twelve percent of users who operate the devices belonging to the device type have reported at least one issue with the device. Based on this data, the user may conclude that it is relatively unlikely that they will encounter any such issues. In embodiments, the statistics can include any aggregated data, including an average value, a total value (e.g., summed across all users/devices), percentiles, and the like. Based on these provided Statistics 315, the user can sort and filter the Entries 320 to find device types which are most relevant to them (or which are most likely to fill the user's particular desires or needs).

FIG. 3B illustrates a GUI 300B displaying aggregated usage statistics that were automatically collected and processed, according to one embodiment disclosed herein. In the illustrated embodiment, the GUI 300B includes additional information for a particular device type, including an Area 330 for Reviews 335. In one embodiment, the GUI 300B was generated upon receiving a user selection of the first Entry 320A in the GUI 300A. As illustrated, the GUI 300B includes information for a “Personal 12.5” Laptop,” including a set of Average Statistics 325, as discussed above. In the illustrated embodiment, three Reviews 335A-C are depicted. As illustrated, in addition to identifying the user who provided each Review 335 and including the content of the Review 335, each Review 335 further indicates one or more relevant user-level statistics for the user.

Specifically, in the illustrated embodiment, each Review 335 indicates the total number of active hours for the authoring user. That is, in the illustrated embodiment, the author of each Review 335 uses or operates the indicated device type. In an embodiment, each user's laptop has recorded and reported, among other data, the total amount of time it has been active and in use. In the illustrated embodiment, Jane Doe, who authored Review 335A, has used the laptop for 416 total hours. Similarly, John Smith, author of Review 335B, has used the laptop for 2 hours, and Adam Jones, author of Review 335C, has used the laptop for 604 total hours. Of course, any user-specific statistic can be included in the GUI 300B in various embodiments.

In some embodiments, the user can sort and/or filter the Reviews 335 based on the user statistics. For example, the user may filter out all reviews from users with less than fifty active hours, if the user assumes that these reviewers will not have used the laptop enough to provide a useful review. Notably, in the illustrated embodiment, Jane Doe and Adam Jones (who have used the laptop for 416 and 604 hours, respectively) have provided positive reviews, specifically mentioning the battery life. In contrast, John Smith has provided a review indicating that the battery life is not good. However, as indicated by the generated aggregate statistics, John has only used the laptop for two hours. Based on this information, the user may decide to discount or ignore the Review 335B.

In some embodiments, the Reviews 335 can also be weighted based in part on the statistics of the corresponding user. For example, if each review includes a numeric rating (e.g., out of five stars), an overall rating can be generated by weighting the individual ratings based on the accompanying user statistics, and aggregating or averaging these weighted scores. In this way, the user may be able to review a more accurate rating that takes into account the experience and usage of the users who provided their individual reviews and ratings.

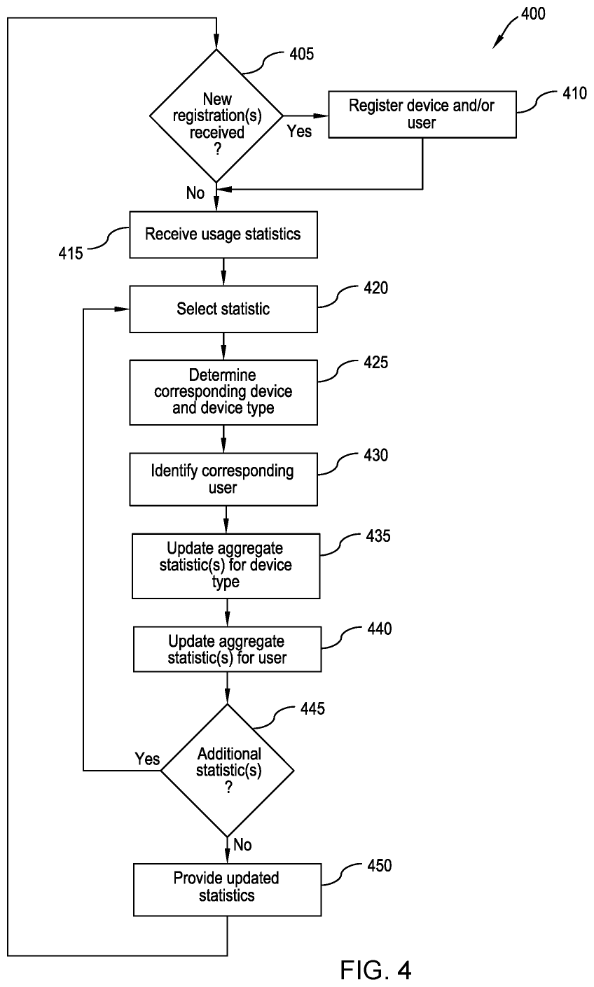

FIG. 4 is a flow diagram illustrating a method 400 for automatically collecting and aggregating usage information, according to one embodiment disclosed herein. The method 400 begins at block 405, where a Statistics Application 230 determines whether any new product registrations have been received. In one embodiment, upon acquiring a product or item, the user can chose to register the product with the Statistics Application 230, if they desire. If no new registrations have been received, the method 400 proceeds to block 415. Alternatively, if at least one new registration has been received, the method 400 proceeds to block 410. At block 410, the Statistics Application 230 processes the received registration(s) to associate the indicated device with the indicated user profile (and to create a new user profile, if required). In this way, device statistics can be tracked and aggregated on a per-user basis. The method 400 then proceeds to block 415.

At block 415, the Statistics Application 230 receives usage statistics for one or more devices. As discussed above, in embodiments, the usage statistics can include any type of data, including total hours in use, total mileage, updated miles per gallon averages, brightness and contrast settings, and the like. In some embodiments, some or all of this data is received from the devices themselves. In one embodiment, the data can also be received from other sources, including user reports, product forums, and the like. At block 420, the Statistics Application 230 selects a statistic from the received usage statistics. The method 400 then proceeds to block 425, where the Statistics Application 230 identifies the corresponding device which the data relates to or describes (e.g., based on a unique identifier associated with each product). Further, the Statistics Application 230 determines the corresponding device type for the identified device (e.g., the model, brand, manufacturer, make, and the like).

The method 400 then proceeds to block 430, where the Statistics Application 230 identifies the user that is associated with the identified device. That is, if the device has been registered with a particular user profile, the Statistics Application 230 identifies this user, such that the user-specific statistics in the user profile can be updated. At block 435, the Statistics Application 230 updates the aggregate statistics for the device type (e.g., the Aggregated Statistics 260 in the corresponding Device Type Record 255). In embodiments, this can include, for example, computing a new average value or a new total value for a statistic, determining an updated percentile, and the like. The method 400 then proceeds to block 440.

At block 440, the Statistics Application 230 updates the aggregate statistics for the identified user. For example, the Statistics Application 230 may update the total number of active hours recorded by the device, indicate whether any problems were reflected in the selected statistic, and the like. The method 400 then continues to block 445, where the Statistics Application 230 determines whether there is at least one additional usage that was received and has not yet been updated. If so, the method 400 returns to block 420, to select the next statistic. Otherwise, the method 400 proceeds to block 450, where the Statistics Application 230 provides the updated statistics.

In one embodiment, providing the updated statistics can include transmitting the statistics to one or more entities that have subscribed to the Statistics Application 230 for aggregate statistics. For example, a retailer may request updated statistics so that its website can be constantly updated. In one embodiment, when a user posts or edits a review, the Statistics Application 230 provides the most up-to-date user-specific statistics that are available for the corresponding device, for inclusion with the review. In some embodiments, this value is static, such that subsequent users can determine the relevant statistics at the time the review was posted. In some embodiments, however, this value is updated each time the corresponding statistics are updated. The method 400 then returns to block 405.

In the illustrated embodiment, the Statistics Application 230 receives usage statistics, and periodically analyzes them to modify or update the relevant aggregate statistics (e.g., once per day). In some embodiments, however, the Statistics Application 230 continuously processes newly-received statistics, in order to update the relevant device-specific statistics and user-specific statistics as the data becomes available. Similarly, in one embodiment, the Statistics Application 230 may continuously provide the updated statistics as they become available. In other embodiments, the Statistics Application 230 periodically transmits these updated statistics (e.g., once each day).

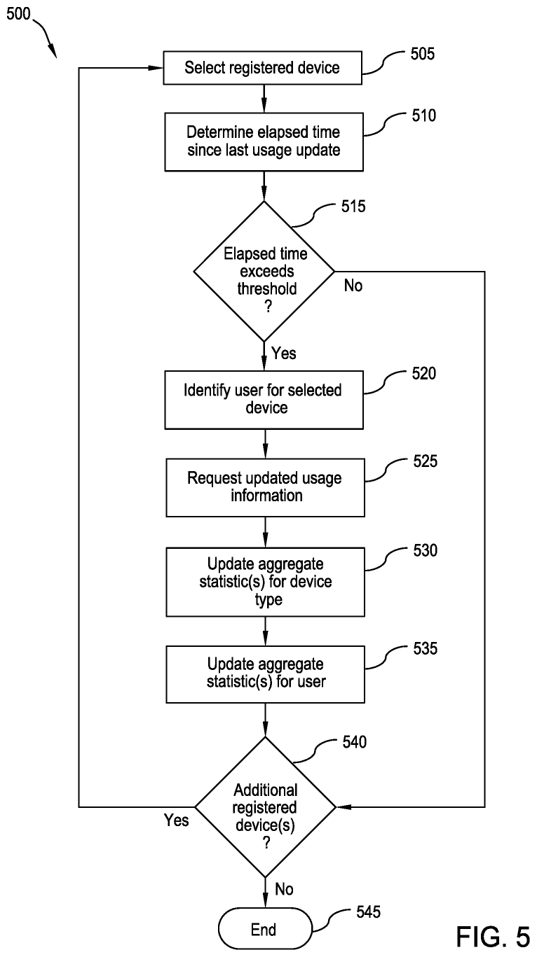

FIG. 5 is a flow diagram illustrating a method 500 for automatically updating aggregated statistics, according to one embodiment disclosed herein. The method 500 begins at block 505, where the Statistics Application 230 selects a device that has been registered with the Statistics Application 230 (e.g., in one or more of the User Profiles 265). The method 500 then proceeds to block 510, where the Statistics Application 230 determines how much time has elapsed since the last usage data was received from the selected device. At block 515, the Statistics Application 230 determines whether this elapsed time exceeds a predefined threshold. In one embodiment, the threshold is configurable by an administrator. If the elapsed time does not exceed the threshold (e.g., data was received relatively recently from the device), the method 500 proceeds to block 540.

Alternatively, if, at block 515, the Statistics Application 230 determines that the predefined threshold of time has been exceeded, the method 500 proceeds to block 520, where the Statistics Application 230 identifies the user or users that are associated with the selected device (e.g., based on the User Profiles 265). At block 525, the Statistics Application 230 transmits a request to the user (e.g., via an identified email, phone number, and the like) to provide updated data. In one embodiment, the user can respond by configuring the selected device to transmit such data (e.g., if they have previously deactivated this data collection). In some embodiments, the user can respond with an indication that the device is no longer in use (e.g., through natural language text, by selecting from a predefined list of options, and the like). Further, in one embodiment, if the device is no longer in use, the user can provide additional detail relating to the cause (e.g., because it broke, because they sold it, etc.)

The method 500 then proceeds to block 530, where the Statistics Application 230 updates the aggregate statistics for the device type of the selected device, based on the response. For example, if the user indicated that the product is no longer in use, the Statistics Application 230 can update an “expected life” of the device based on this indication. At block 535, the Statistics Application 230 similarly updates the aggregate statistics for the identified user. For example, if the device is no longer in use, the Statistics Application 230 can remove this registered device from the user's profile. Similarly, if the response includes any reported issues, the Statistics Application 230 can update the device statistics and/or user statistics based on this data. The method 500 then proceeds to block 540, where the Statistics Application 230 determines whether there is at least one additional device that has yet to be analyzed. If so, the method 500 returns to block 505. Otherwise, the method 500 terminates at block 545.

In some embodiments, if the user indicates that a device is no longer in use, the Statistics Application 230 identifies and updates any reviews the user left for the device. For example, in one embodiment, the Statistics Application 230 adds an indication that the device is no longer in use, and identifies why (if known). In one embodiment, if the elapsed time since data was last received for a device exceeds a predefined threshold (or if a predefined number of requests relating to the device have been ignored by the user), the Statistics Application 230 assumes that the device is no longer in use, and proceeds as discussed above.

Further, in one embodiment, the Statistics Application 230 periodically requests updates from users, regardless of whether the device is still transmitting updated statistics. For example, in one embodiment, the Statistics Application 230 periodically identifies reviews left by each user, and, if a predefined period of time has passed since the review was affirmed or edited, the Statistics Application 230 can transmit a request to the user to affirm the contents of the review or modify the review. In such an embodiment, the Statistics Application 230 can ensure that the posted reviews for a given product remain as up-to-date as possible, and account for any changes or issues that have arisen since the review was originally posted.

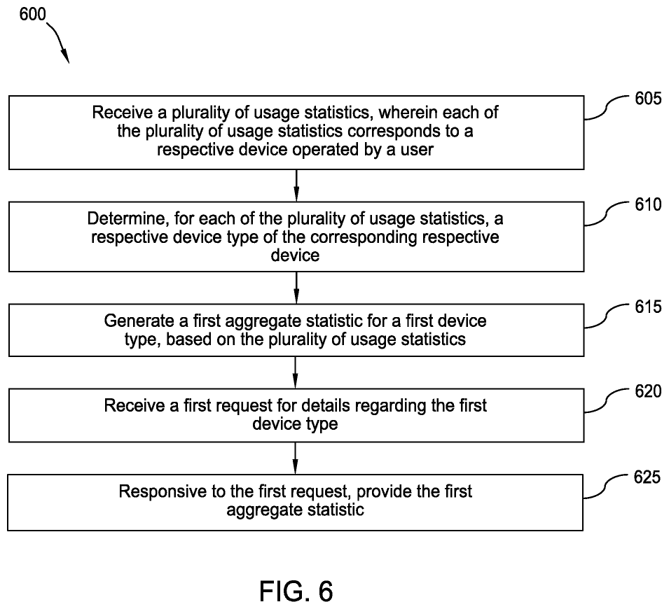

FIG. 6 is a flow diagram illustrating a method 600 for collecting usage data, according to one embodiment disclosed herein. The method 600 begins at block 605, where a Statistics Application 230 receives a plurality of usage statistics, wherein each of the plurality of usage statistics corresponds to a respective device operated by a user. At block 610, the Statistics Application 230 determines, for each of the plurality of usage statistics, a respective device type of the corresponding respective device. The method 600 then proceeds to block 615, where the Statistics Application 230 generates a first aggregate statistic for a first device type, based on the plurality of usage statistics. Further, at block 620, the Statistics Application 230 receives a first request for details regarding the first device type. Finally, at block 625, the Statistics Application 230 provides the first aggregate statistic, responsive to the first request.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the preceding, reference is made to embodiments presented in this disclosure. However, the scope of the present disclosure is not limited to specific described embodiments. Instead, any combination of the preceding features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.”

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Embodiments of the invention may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud computing resources are provided to a user on a pay-per-use basis, where users are charged only for the computing resources actually used (e.g. an amount of storage space consumed by a user or a number of virtualized systems instantiated by the user). A user can access any of the resources that reside in the cloud at any time, and from anywhere across the Internet. In context of the present invention, a user may access applications (e.g., the Statistics Application 230) or related data available in the cloud. For example, the Statistics Application 230 could execute on a computing system in the cloud and receive and process usage data. In such a case, the Statistics Application 230 could generate aggregated statistics and store device type-specific and user-specific statistics at a storage location in the cloud. Doing so allows a user to access this information from any computing system attached to a network connected to the cloud (e.g., the Internet).

While the foregoing is directed to embodiments of the present invention, other and further embodiments of the invention may be devised without departing from the basic scope thereof, and the scope thereof is determined by the claims that follow.

What is claimed is:

1. A method comprising:
receiving a plurality of usage statistics, wherein each of the plurality of usage statistics corresponds to a respective device operated by a user;
determining, for each of the plurality of usage statistics, a respective device type of the corresponding respective device;
generating, by operation of one or more computer processors, a first aggregate statistic for a first device type, based on the plurality of usage statistics;
receiving a first request for details regarding the first device type; and
responsive to the first request, providing the first aggregate statistic.

2. The method of claim 1, wherein the plurality of usage statistics include: (i) a total active duration of the respective device; (ii) an average active duration per session for the respective device; and (iii) an indication as to any problems identified for the respective device.

3. The method of claim 1, the method further comprising:
generating a second aggregate statistic for a second device type, based on the plurality of usage statistics;
generating a third aggregate statistic for a third device type, based on the plurality of usage statistics;
receiving a second request for details regarding the first, second, and third device types; and
responsive to the second request:
sorting the first, second and third device types based on the first, second, and third aggregate statistics; and
providing the sorted first, second, and third aggregate statistics.

4. The method of claim 1, the method further comprising:
determining that a predefined period of time has passed since a usage statistic was received for a first device operated by a first user; and
transmitting, to the first user, a request for updated usage statistics for the first device.

5. The method of claim 1, the method further comprising:
determining that a first device is no longer in use, wherein the first device belongs to the first device type; and
updating the first aggregate statistic based on the determination that the first device is no longer in use.

6. The method of claim 1, the method further comprising:
receiving a plurality of reports, wherein each of the plurality of reports includes natural language text and was submitted to remedy an issue discovered during use of a device;
analyzing the plurality of reports to identify a set of reports that are relevant to the first device type; and
determining one or more new usage statistics by processing the identified set of complains using one or more natural language processing (NLP) techniques; and
updating the first aggregate statistic based on the one or more new usage statistics.

7. The method of claim 1, the method further comprising:
identifying, from the plurality of usage statistics, a set of usage statistics that are relevant to a first device operated by a first user, wherein the first device is of a first device type;
generating a first user statistic based on the set of usage statistics;
associating the first user statistic with the first user;
identifying one or more reviews authored by the first user, wherein each of the one or more reviews is associated with the first device type; and
associating the first user statistic with the identified one or more reviews.

8. A computer-readable storage medium having computer-readable program code embodied therewith, the computer-readable program code executable by one or more computer processors to perform an operation comprising:
receiving a plurality of usage statistics, wherein each of the plurality of usage statistics corresponds to a respective device operated by a user;
determining, for each of the plurality of usage statistics, a respective device type of the corresponding respective device;
generating a first aggregate statistic for a first device type, based on the plurality of usage statistics;
receiving a first request for details regarding the first device type; and
responsive to the first request, providing the first aggregate statistic.

9. The computer-readable storage medium of claim 8, wherein the plurality of usage statistics include: (i) a total active duration of the respective device; (ii) an average active duration per session for the respective device; and (iii) an indication as to any problems identified for the respective device.

10. The computer-readable storage medium of claim 8, the operation further comprising:
generating a second aggregate statistic for a second device type, based on the plurality of usage statistics;
generating a third aggregate statistic for a third device type, based on the plurality of usage statistics;
receiving a second request for details regarding the first, second, and third device types; and
responsive to the second request:
sorting the first, second and third device types based on the first, second, and third aggregate statistics; and
providing the sorted first, second, and third aggregate statistics.

11. The computer-readable storage medium of claim 8, the operation further comprising:
determining that a predefined period of time has passed since a usage statistic was received for a first device operated by a first user; and
transmitting, to the first user, a request for updated usage statistics for the first device.

12. The computer-readable storage medium of claim 8, the operation further comprising:
determining that a first device is no longer in use, wherein the first device belongs to the first device type; and
updating the first aggregate statistic based on the determination that the first device is no longer in use.

13. The computer-readable storage medium of claim 8, the operation further comprising:
receiving a plurality of reports, wherein each of the plurality of reports includes natural language text and was submitted to remedy an issue discovered during use of a device;
analyzing the plurality of reports to identify a set of reports that are relevant to the first device type; and
determining one or more new usage statistics by processing the identified set of complains using one or more natural language processing (NLP) techniques; and
updating the first aggregate statistic based on the one or more new usage statistics.

14. The computer-readable storage medium of claim 8, the operation further comprising:
identifying, from the plurality of usage statistics, a set of usage statistics that are relevant to a first device operated by a first user, wherein the first device is of a first device type;
generating a first user statistic based on the set of usage statistics;
associating the first user statistic with the first user;
identifying one or more reviews authored by the first user, wherein each of the one or more reviews is associated with the first device type; and
associating the first user statistic with the identified one or more reviews.

15. A system comprising:
one or more computer processors; and
a memory containing a program which when executed by the one or more computer processors performs an operation, the operation comprising:
receiving a plurality of usage statistics, wherein each of the plurality of usage statistics corresponds to a respective device operated by a user;
determining, for each of the plurality of usage statistics, a respective device type of the corresponding respective device;
generating a first aggregate statistic for a first device type, based on the plurality of usage statistics;
receiving a first request for details regarding the first device type; and
responsive to the first request, providing the first aggregate statistic.

16. The system of claim 15, the operation further comprising:
generating a second aggregate statistic for a second device type, based on the plurality of usage statistics;
generating a third aggregate statistic for a third device type, based on the plurality of usage statistics;
receiving a second request for details regarding the first, second, and third device types; and
responsive to the second request:
sorting the first, second and third device types based on the first, second, and third aggregate statistics; and
providing the sorted first, second, and third aggregate statistics.

17. The system of claim 15, the operation further comprising:
determining that a predefined period of time has passed since a usage statistic was received for a first device operated by a first user; and
transmitting, to the first user, a request for updated usage statistics for the first device.

18. The system of claim 15, the operation further comprising:
determining that a first device is no longer in use, wherein the first device belongs to the first device type; and
updating the first aggregate statistic based on the determination that the first device is no longer in use.

19. The system of claim 15, the operation further comprising:
receiving a plurality of reports, wherein each of the plurality of reports includes natural language text and was submitted to remedy an issue discovered during use of a device;
analyzing the plurality of reports to identify a set of reports that are relevant to the first device type; and
determining one or more new usage statistics by processing the identified set of complains using one or more natural language processing (NLP) techniques; and
updating the first aggregate statistic based on the one or more new usage statistics.

20. The system of claim 15, the operation further comprising:
identifying, from the plurality of usage statistics, a set of usage statistics that are relevant to a first device operated by a first user, wherein the first device is of a first device type;
generating a first user statistic based on the set of usage statistics;
associating the first user statistic with the first user;
identifying one or more reviews authored by the first user, wherein each of the one or more reviews is associated with the first device type; and
associating the first user statistic with the identified one or more reviews.
